(19) United States
(12) Patent Application Publication
(10) Pub. No.: US 2019/0363319 A1
(43) Pub. Date: Nov. 28, 2019

(54) BATTERY PACK STACKING STRUCTURE

(71) Applicant: WEI HAO LIAO, Taipei (TW)

(72) Inventor: WEI HAO LIAO, Taipei (TW)

(21) Appl. No.: 15/985,713

(22) Filed: May 22, 2018

(51) Int. Cl. H01M 2/10; H01M 2/26; H01M 2/30

(52) U.S. Cl. CPC H01M 2/1016; H01M 2/30; H01M 2/26

(57) ABSTRACT

A battery pack stacking structure, whose components comprise a frame body, at least one or more battery cells and a housing. In particular, the frame body is rectangular, and a symmetrical combination structure is configured on the corresponding position of each corner around the periphery of the two opposite surfaces. The combination structure includes a convex portion on the same side surface and a concave portion on the other side surface, and the convex portion and the concave portion provide a combined pattern for mutual fitting, so that the plurality of frame bodies can be fitted by fitting the convex portion on the same side surface with the concave portion on the other side surface to freely extend the combination of a plurality of frame bodies.

### BACKGROUND OF INVENTION

### 1. Field of the Invention

The present invention relates generally to a battery pack design, and more particularly to a battery pack stacking structure.

### 2. Description of Related Art

Commonly used wireless hand tools, remote control aircrafts, automobiles and portable electrical appliances and other high-power demand products have long been using nickel-cadmium batteries or lead-acid batteries. In order to implement environmental protection, the European regulations in recent years prohibit the entry of metallic substances containing mercury, lead, and cadmium. The pollution of lead and cadmium metals produced by these battery reactions cannot be ignored, so the demand for alternative batteries is urgent. Some of them can be replaced by nickel-metal hydride batteries, but the first choice is still the lithium ion batteries with high energy density. In the past, the applications of lithium batteries were mostly in low current and low power. At present, the high power research and application of lithium battery has become a hot field, especially for light and safe consideration.

At present, the existing batteries are mostly of fixed size and volume, which are tailored to specific objects, and the electricity is fixed and cannot be changed. Once there is an increase in the demand for electricity, there is no alternative but to produce it. Although it can be temporarily solved by temporary series and parallel connection, it is always unsuitable.

Due to the dramatic improvement in the performance of various types of electric vehicles, under the current energy depletion crisis that may be faced, the industry is trying to develop and provide rechargeable lithium batteries or secondary lithium batteries with high energy density and high output. Therefore, it is urgent for the industry to provide a solid state battery that is modular and can significantly increase the endurance power and long service life.

### SUMMARY OF THE INVENTION

In view of the above problems encountered by the industry, the present invention aims to provide a battery pack stacking structure, in which a plurality of battery packs can be freely assembled into an integral by the fixed electricity of a single battery pack to meet the demand for large power.

In order to achieve the above objective, the battery pack stacking structure designed by the inventor comprises a frame body, at least one or more battery cells and a housing. In particular, the frame body is rectangular, and a symmetrical combination structure is configured on the corresponding position of each corner around the periphery of the two opposite surfaces. The combination structure includes a convex portion on the same side surface and a concave portion on the other side surface, and the convex portion and the concave portion provide a combined pattern for mutual fitting, so that the plurality of frame bodies can be fitted by fitting the convex portion on the same side surface with the concave portion on the other side surface to extend the combination of a plurality of frame bodies.

The above-mentioned frame body may allow for combining at least one or more battery cells. The battery cell comprises a positive electrode, a negative electrode and a separator membrane, and has positive and negative electrode ears, respectively.

The above-mentioned frame body further comprises two opposing housings for covering the outer sides of the battery cell. The housings are combined with the frame body to form a completely closed and hollow space, so that the battery cells can be embedded, positioned and hidden therein.

The above-mentioned housing can be made integrally or separately to form two mutually matched housings with cross section in C shape.

The upper periphery of the above-mentioned frame body is provided with two sets of positive and negative terminals at an interval.

The positive and negative electrode ear types of the above-mentioned battery cell are the types for matching with the terminals on the corresponding positions on the frame body, and include the combination type of an open circular hole and a closed circular hole.

The convex portion and the concave portion in the above-mentioned combined structure of the housing can be in a matched conical shape.

### BRIEF DESCRIPTION OF THE DRAWINGS

FIG. 1 is a schematic exploded diagram of a battery pack structure according to a preferred embodiment of the present invention.

FIG. 2 is a schematic assembly diagram of a battery pack according to a preferred embodiment of the present invention.

FIG. 3 is a partial exploded diagram of a frame body according to a preferred embodiment of the present invention.

FIG. 4 is a perspective view of a frame body from another angle according to a preferred embodiment of the present invention.

FIG. 5 is a schematic extended assembly diagram of a plurality of battery packs according to a preferred embodiment of the present invention.

### DETAILED DESCRIPTION OF THE INVENTION

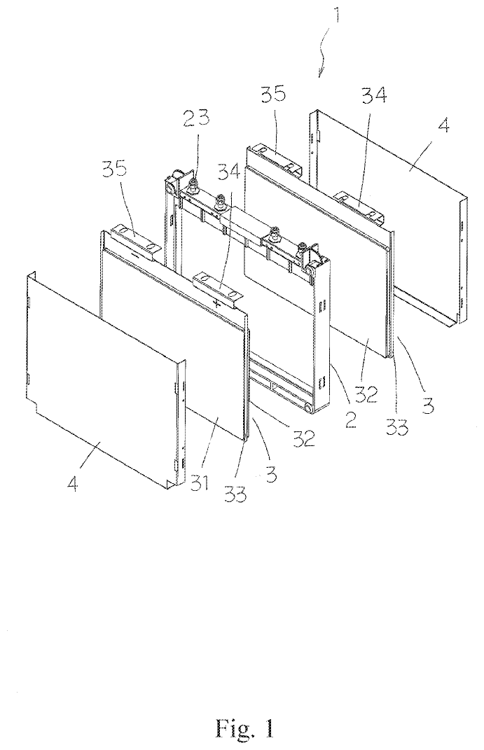

Referring to FIG. 1, which is a schematic diagram of a battery pack stacking structure of a preferred embodiment, the battery pack (1) comprises a frame body (2), at least one or more battery cells (3) and a housing (4).

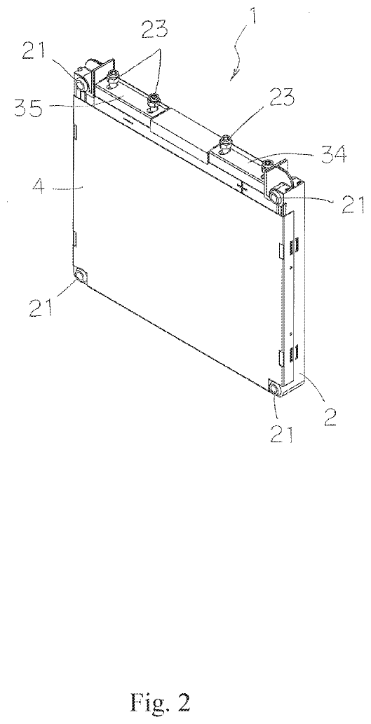

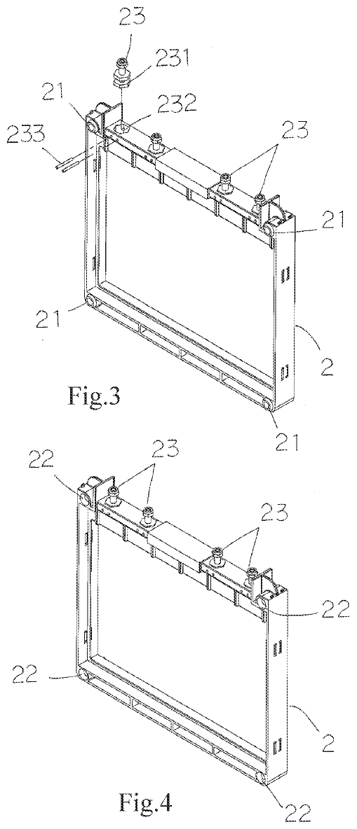

Referring to FIGS. 2-4, the frame body (2) has a rectangular shape. A symmetrical combination structure is configured on the corresponding position of each corner around the periphery of the two opposite surfaces, and includes a conical convex portion (21) at each corner of the same side surface and a conical concave portion (22) at each corner of the other side surface. The convex portion (21) and the concave portion (22) provide a combined pattern for mutual fitting, so that the plurality of frame bodies (2) can be fitted by fitting the convex portion (21) on the same side surface with the concave portion (22) on the other side surface to axially extend the combination of a plurality of frame bodies (2). The upper periphery of the frame body (2) (only for illustration according to the direction shown in the drawing, not as a limitation) is provided with two sets of positive and negative terminals (23) at an interval. The terminal (23) is designed to form a type of two spacer plates (231) at one combination end. When the terminal (23) is embedded in the corresponding groove (232) of the frame body (2), two penetration pins (233) are inserted through the space between the spacer plates (231) to complete combination and achieve position limiting action, thereby achieving convenient effect of assembly and disassembly.

The battery cell (3) is the same as the conventional one, and comprises a positive electrode (31), a negative electrode (32) and a separator membrane (33), and the upper periphery (only for illustration according to the direction shown in the drawing, not as a limitation) has positive and negative electrode ears (34, 35).

The housing (4) can be made of metals for covering the outer sides of the battery cell, and is combined with the frame body (2) to form a closed and hollow space, so that one or more battery cells (3) can be embedded and hidden therein to achieve protection and heat dissipation effect. The housing (4) can be made in an integral or separation form. In this embodiment, a separate type is adopted, consisting of two mutually matched housings (4) in C shape.

With the combination of the above components, the frame body (2) in the present embodiment has a thickness sufficient to accommodate two battery cells (3), and the two battery cells (3) are placed side by side from the two opposite directions of the frame body (2). In combination, depending on the user's various requirements for the function of the battery, the positive and negative electrode ears (34, 35) of the two battery cells (3) can be freely connected in series or in parallel type with the positive and negative terminals (23) on the corresponding positions of the frame body (2) to complete the electrical connection. Then, the two opposing housings (4) with cross section in C shape are respectively coupled to the opposite sides of the frame body (2) to make the two battery cells (3) be covered by the housings (4) and the frame body (2) as an integral, and become a series type battery pack or parallel type battery pack.

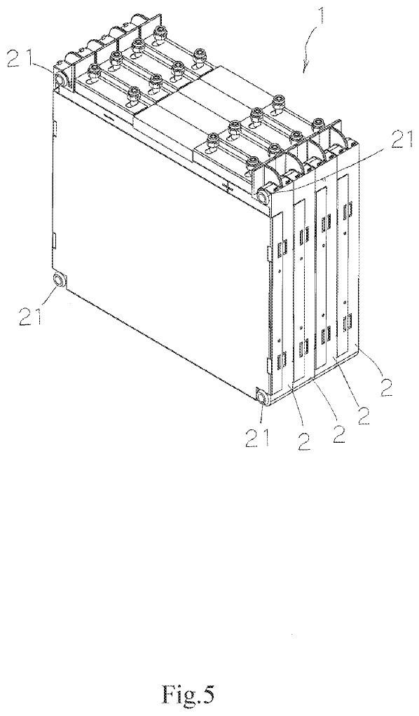

Referring to FIGS. 2, 4, and 5, the main design features of the present invention are that a large number of battery packs (1) can be combined and extended in a side-by-side manner to form an integrated battery structure with a large quantity of electricity. In particular, each of the plural battery packs (1) uses a convex portion (21) formed at each corner around the periphery of the same side surface of the frame body (2) to fit to the corresponding concave portion (22) at each corner around the periphery of the corresponding side surface of the adjacent frame body (2) to achieve a combination type.

By the combination of at least two battery packs, the fitting between the corresponding and matched convex portion (21) and concave portion (22) on the frame body (1) can achieve extension in quantity, which can realize actual demand for large quantity of electricity.

In addition, the positive and negative electrode ears (34, 35) of the above-mentioned battery cell (3) are matched with the terminals (23) at the corresponding positions of the frame body (2), thereby allowing the positive and negative electrode ears (34, 35) to achieve a convenient and fast combination effect. In a preferred embodiment, a combination type of an open circular hole and a closed circular hole can be adopted.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

1. A battery pack stacking structure, which comprises a frame body, at least one or more battery cells and a housing; featuring in that the frame body has a rectangular shape, and a symmetrical combination structure is configured on the corresponding position of each corner around the periphery of the two opposite surfaces and includes a conical convex portion on the same side surface and a conical concave portion on the other side surface; the convex portion and the concave portion provide a combined pattern for mutual fitting, so that the plurality of frame bodies can be fitted by fitting the convex portion on the same side surface with the concave portion on the other side surface to achieve combination and extension action.

2. The battery pack stacking structure defined in claim 1, wherein the frame body can allow for combining at least more than one battery cells. The battery cell comprises a positive electrode, a negative electrode and a separator membrane, and has positive and negative electrode ears, respectively.

3. The battery pack stacking structure defined in claim 1, wherein the frame body further comprises two opposing housings for covering the outer side of the battery cell. The housings are combined with the frame body to form a completely closed and hollow space, making the battery cells be embedded, positioned and hidden therein.

4. The battery pack stacking structure defined in claim 1, wherein the housing can be made integrally or separately to from two mutually matched opposing housings with cross section in C shape.

5. The battery pack stacking structure defined in claim 1, wherein the upper periphery of the frame body is provided with two sets of positive and negative terminals at an interval.

6. The battery pack stacking structure defined in claim 2, wherein the positive and negative electrode ear types of the battery cell are the types for matching with the terminals on the corresponding positions on the frame body, and include the combination type of an open circular hole and a closed circular hole.

7. The battery pack stacking structure defined in claim 1, wherein the convex portion and the concave portion of the combination structure can be in a matched conical shape.
